(19) United States
(12) Patent Application Publication
(10) Pub. No.: US 2004/0119257 A1
(43) Pub. Date: Jun. 24, 2004

(54) Book carrier organizer tray

(76) Inventors: Janet S. Nelson, Sun Prairie, WI (US); Douglas E. Engbring, Madison, WI (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 10/323,862

(22) Filed: Dec. 18, 2002

(51) Int. Cl. B62B 3/00

(52) U.S. Cl. 280/47.35

(57) ABSTRACT

A book carrier organizer tray includes a base sized for resting on a book carrier shelf. The base includes a top surface and a plurality of sides. The top surface of the base includes a writing surface, preferably inclined, and defines a plurality of receptacles. The writing surface includes a front edge, a rear edge and a pair of side edges. The elevation of the front edge of the writing surface is lower than the elevation of the rear edge. The receptacles are adapted for receiving articles of different sizes and shapes. The tray is combinable with a mobile book carrier which comprises a frame and a plurality of rotatable members. The frame includes a plurality of supporting members which define a plurality of book receiving surfaces or shelves. The organizer tray is carried by one of the book receiving surfaces.

### FIELD OF THE INVENTION

The present invention relates to an organizer tray for use on a mobile carrier, such as a library book truck or book carrier. Mobile book carriers including book trucks are generally used in libraries or other facilities for carrying and moving books. They typically have a series of shelves for storing books being returned to the shelves after such books are used or read within the library by library users, and not reshelved by the user after use, or after the books are deposited for return to the library by users who check out books for use outside the library.

Librarians and other users frequently use the book carrier as a mobile work station to hold various supplies such as notepads, paper clips, pencils, cards and other writing implements as well as supplies for book repair and the like. Unfortunately, the flat shelves of the book carrier are not conducive to holding a plurality of small objects or items such as mentioned above. Objects can roll, tilt or fall from the shelf, particularly during carrier movement and repeated starting and stopping.

In addition, while each shelf of the book carrier is designed to stack numerous books, the shelves, whether flat or slanted, are not particularly well suited as a writing surface.

Accordingly, it is an object of the present invention to provide an organizer tray particularly but not exclusively suitable for use on a book carrier shelf which addresses at least some of the difficulties with standard book carriers.

It is another object of the present invention to provide an organizer tray including an inclined writing surface suitable for use on a book carrier.

It is a further object of the present invention to provide such an organizer tray with receptacles adapted for receiving differently sized and shaped objects.

It is yet another object of the present invention to provide a combined mobile book carrier and a removable organizer tray with the features described above.

### SUMMARY OF THE INVENTION

The present invention provides an organizer tray which comprises a base suitable for resting on a book carrier shelf. The base includes a plurality of sides and a top surface which is carried by the plurality of sides. The top surface defines at least a substantially planar writing surface, preferably an inclined writing surface. The writing surface has a front edge, a rear edge and a plurality of side edges and is preferably inclined such that the elevation of the front edge is less than the elevation of the rear edge. The top surface of the tray may also define a plurality of receptacles on one or both sides of the writing surface. The receptacles are adapted for receiving articles of different sizes and shapes, such as paper clips of different sizes or shapes, pens, pencils and the like as well as book repair items such as glue containers, tape dispensers and the like.

### BRIEF DESCRIPTION OF THE DRAWINGS

FIG. 1 shows a perspective view of a combination mobile book carrier and a removable organizer tray of the present invention;

FIG. 2 shows a perspective view of the organizer tray;

FIG. 3 shows a sectional view along line 3-3 of FIG. 2;

FIG. 4 shows a sectional view along line 4-4 of FIG. 2;

FIG. 5 shows a front view of the organizer tray;

FIG. 6 shows a rear view of the organizer tray;

FIG. 7 shows a left side view of the organizer tray;

FIG. 8 shows a right side view of the organizer tray;

FIG. 9 shows a top view of the organizer tray; and

FIG. 10 shows a bottom view of the organizer tray.

### DETAILED DESCRIPTION

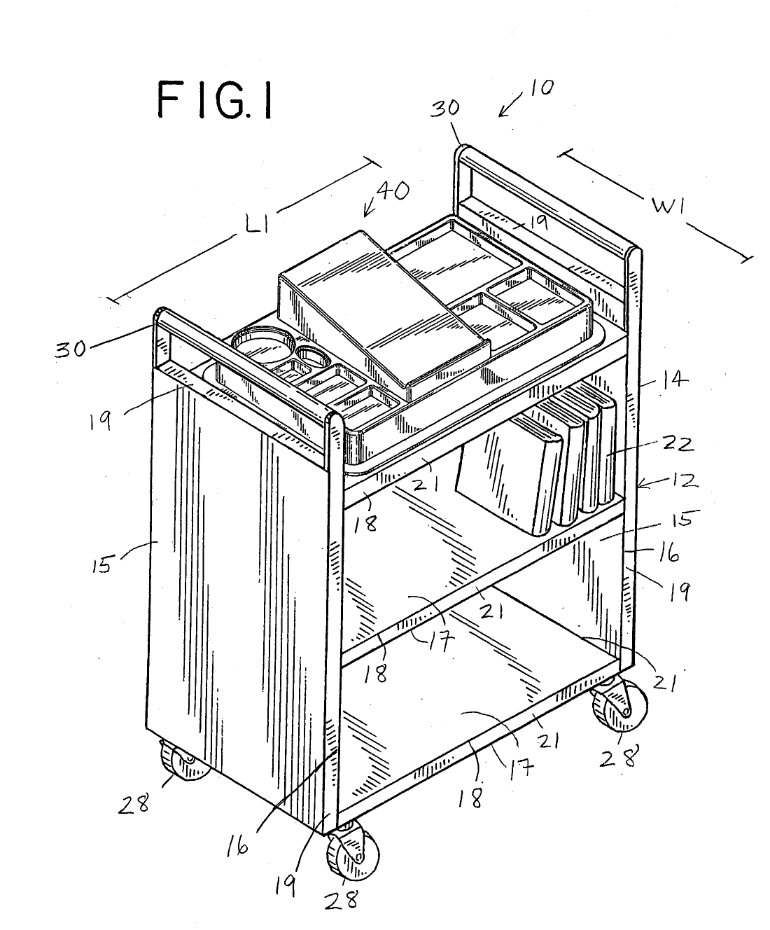

FIG. 1 illustrates a combination mobile book carrier and removable organizer tray, the combination being designated at 10, which includes a mobile book carrier 12 and an organizer tray 40. For purposes of this invention, a mobile book carrier is defined broadly to include any type of mobile book or supply device without limitation to book carriers commonly known as book trucks.

Turning first to the mobile book carrier 12, FIG. 1 illustrates a common style of book carrier or truck. The carrier has a frame 14 that may include, by way of example but not limitation, vertical end panels 16 and horizontal shelves 18. The vertical end panels 16 are located in spaced relation to each other, and intermediate vertical panels or supports may also be provided. The vertical and horizontal members 16, 18 have side or top surfaces 15 and 17, respectively, and edge surfaces 19 and 21, respectively. The horizontal shelves 18 extend between vertical end panels 16 for receiving books 22, video tapes, magazines or other items for transport in the library, resource center or similar setting. For purposes of this description, the book shelves of the carrier generally have a length L1 and a width W1.

For portability the lowest shelf 18 or floor of the carrier mounts a plurality of wheels 28, preferably pivotally mounted for rolling or turning the carrier. For grasping the carrier, side rails 30 are positioned adjacent the uppermost shelf 18.

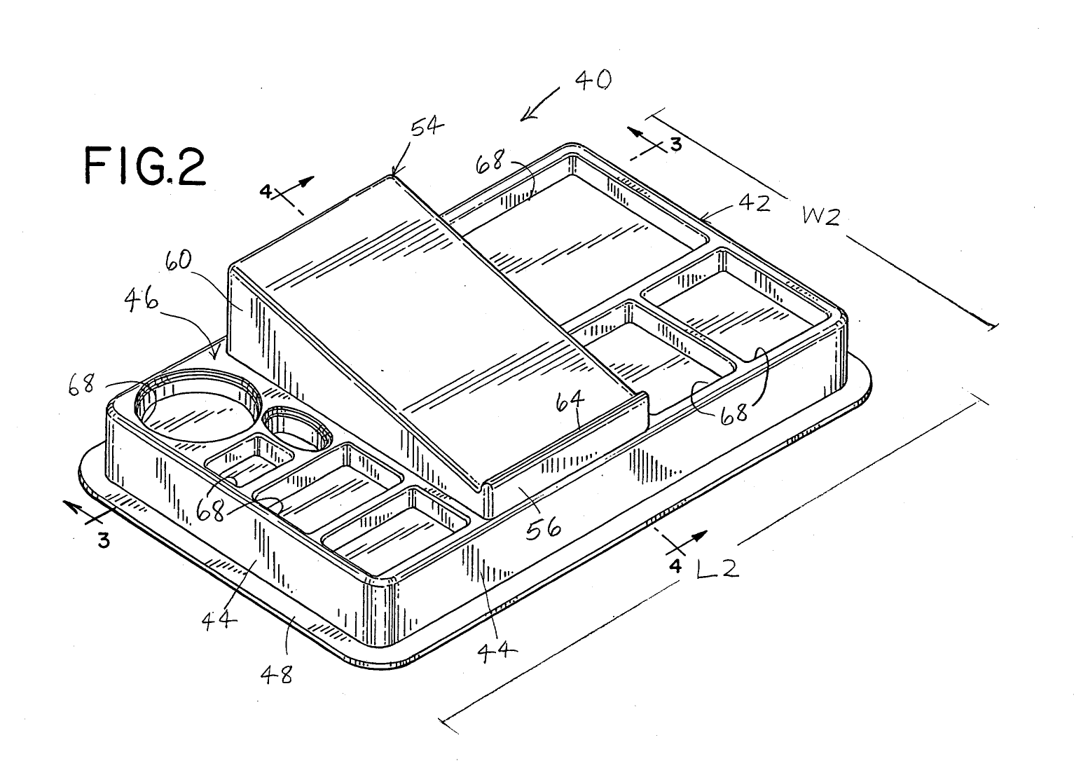

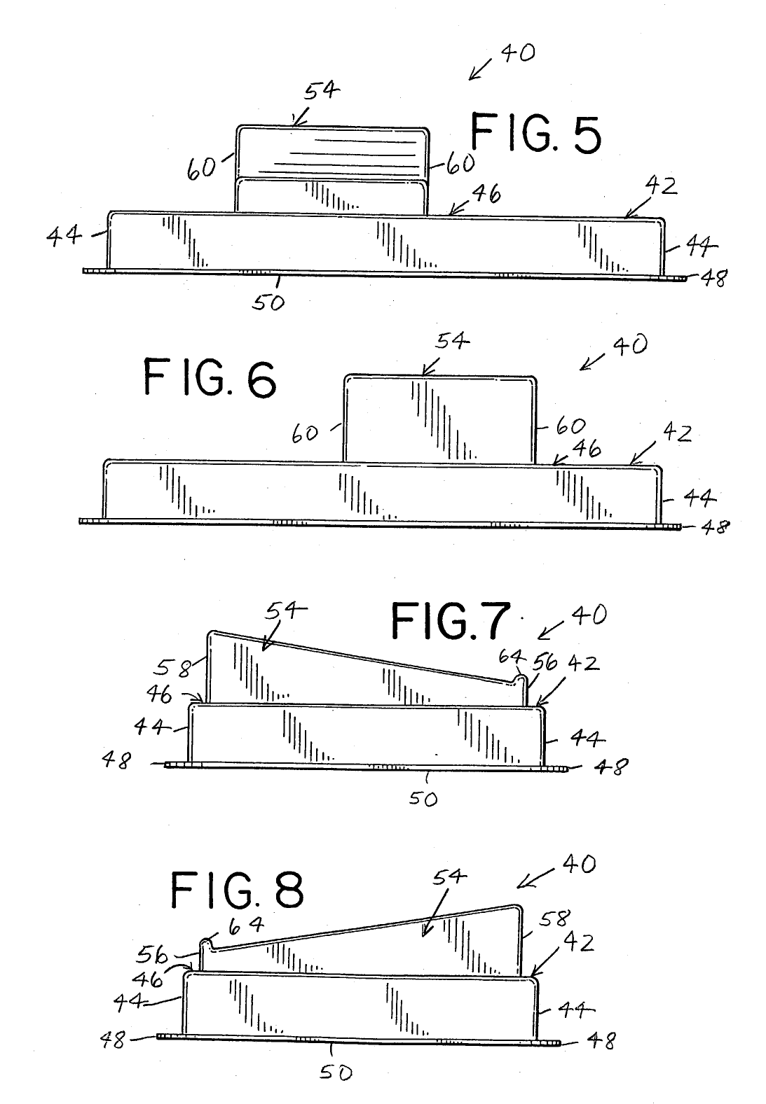

Turning next to the organizer tray 40, the organizer tray is adapted to rest, when in use, on the uppermost shelf 18 of the book carrier 12. FIGS. 2-8 show the tray in greater detail. The organizer tray 40 includes a base, generally at 42, which has a length L2 and a width W2 which are preferably the same size or smaller than the length L1 and the width W1 of the book shelves 18. Although the tray 40 will normally rest, either directly or indirectly on the uppermost shelf, (or upper portion of the frame 14) when in use, it is also contemplated that the tray 40 may be placed on one of the lower book shelves, as needed—for example when not in use.

The base 42 of the tray 40 includes a plurality of side walls 44 and a top surface, generally at 46, which is carried either directly or indirectly by the side walls. A horizontal flange 48 extends from a lower edge of the side walls 44 and defines a bottom edge or surface 50 that rests on the shelf 18. Between the flanges 48 along the bottom edge 50, the base 42 is substantially open to define a hollow interior 52 of the tray 40.

The top surface 46 of the base 42 defines a substantially planar writing surface, generally at 54, which may be horizontal but is preferably inclined for ease of use. The writing surface 54 is preferably partially raised above and inclined in relation to the remaining top surface 46 of the base 42. The writing surface 54 has a front edge 56, a rear edge 58, and a pair of side edges 60. The front edge 56 is lower than the rear edge 58 and includes a raised stop member 64 which is positioned near the front edge 56 to hold any pens or pencils. The writing surface 54 may also include other securing devices or the like such as, for example, a pre-attached clip to further aid in securing sheets or paper or writing articles.

The top surface 46 of the base 42 further defines a plurality of receptacles 68. The receptacles 68 may be positioned on one or both sides of the writing surface 54. Depending upon the size and orientation of the receptacles, certain receptacles may be positioned adjacent the writing surface 54, such as the oval receptacle, whereas other receptacles may be positioned spaced from or remote from the writing surface 54, such as the receptacle immediately left of the oval receptacle.

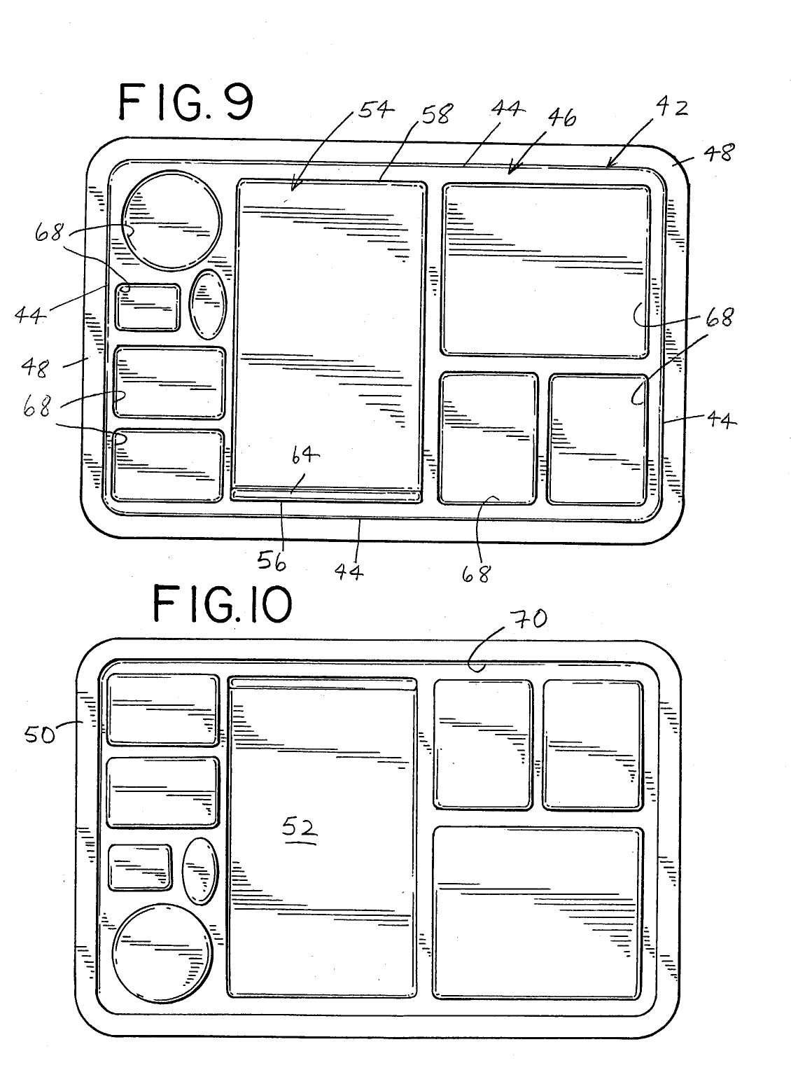

The receptacles 68 may have various sizes and shapes for receiving numerous objects. FIGS. 2 and 9 illustrate receptacles having square, rectangular, circular, and oval shapes in various sizes. These shapes and sizes are shown by way of example and they are not intended to limit the invention. In fact, numerous other shapes and sizes are also possible. In addition, all or a portion of the top surface 46 which defines the receptacles may be inclined in relation to a horizontal reference line.

Variations are also possible in the positioning and orientation of the writing surface 54. Although the writing surface 54 is shown as approximately centrally positioned on the organizer tray 40, the writing surface may be positioned at either end of the tray or, alternatively, the writing surface may be located at other intermediate positions. It is also possible for more than one writing surface to be located on the organizer tray without departing from the scope of this invention. By way of example and not limitation, the tray may include two writing surfaces with one or more receptacles positioned between the writing surfaces. In addition to the variations already discussed, modifications in the elevation and size of the writing surface 54 are possible.

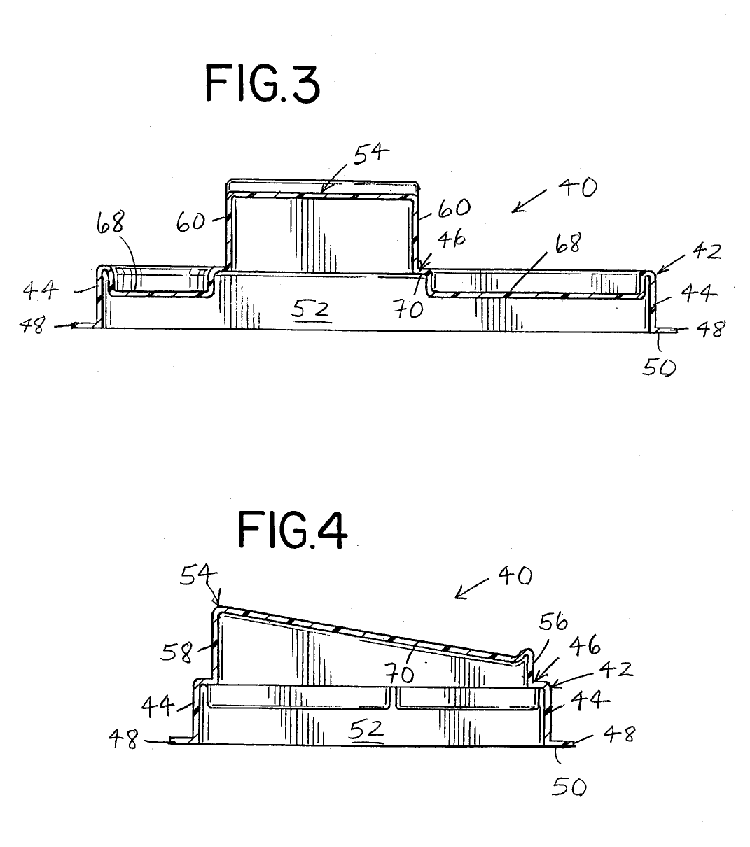

The organizer tray 40 is preferably made from any suitable, vacuum formed or injection molded, rigid plastic of sufficient strength. The method of manufacturing the tray 40 results in the formation of the hollow interior 52. As shown in FIGS. 3, 4, and 10, the hollow interior is formed by a bottom surface 70 which is inverted with respect to the top surface 46 where, for example, each receptacle 68 in the top surface 46 forms a corresponding projection in the bottom surface 70. The side walls 44 may include a slight draft or taper to allow easy removable from the mold. As a result, the organizer tray is lightweight, strong and durable.

During use, the tray provides at least one writing surface, preferably inclined, which is suitable for writing thereon by the user. Articles for writing may be placed on the writing surface and secured thereto so that the user may write on such articles while support is provided by the writing surface. The slope of the writing surface assists in providing the user with a convenient writing surface. Although the angle of the writing surface is generally shown as about 15 degrees as measured from a horizontal reference, other acute angles, such as up to 45 degrees or more, are possible without departing from the scope of this invention.

The convenience of the organizing tray is enhanced by the receptacles which are capable of receiving a plurality of differently sized objects. The objects may include, by way of example but not limitation, cards, paper clips, notepads, adhesive notes, tape dispensers, glue containers, pens, pencils, markers, writing paper, and other supplies. Another advantage provided by the organizer tray is that it allows for the convenient transfer of many items at once when the tray is either fully or partially loaded with objects and writing articles.

The organizer tray is combinable with the mobile book carrier to provide a mobile workstation. The tray may be removably placed on any one of the book shelves of the mobile book carrier, as contemplated by the user. The tray may be easily transferred between book shelves, or, alternatively, the tray may be transferred to and from the mobile book carrier from other surrounding surfaces.

Whereas a preferred form of the invention has been shown and described herein, it is understood that other modifications, alterations and substitutions may be made to invention without departing from the scope of the claims.

1. A book carrier organizer tray comprising:
a base sized for resting on a book carrier shelf and including a plurality of sides and a top surface which is carried by the plurality of sides, the top surface defining at least one substantially planar writing surface; and
a plurality of receptacles defined in the top surface on one or both sides of the writing surface and adapted for receiving articles of different sizes and shapes.

2. The book carrier organizer tray of claim 1 wherein the base has a front side and a rear side in opposing relation to one another and the writing surface extends therebetween.

3. The book carrier organizer tray of claim 1 wherein the writing surface includes a raised stop member adjacent a front edge of the writing surface.

4. The book carrier organizer tray of claim 1 wherein the top surface of the base is substantially horizontal and the writing surface is inclined in relation to the remainder of the top surface.

5. The book carrier organizer tray of claim 1 wherein at least one of the plurality of receptacles is located on each side of the writing surface.

6. The book carrier organizer tray of claim 1 wherein at least one of the plurality of receptacles is located adjacent the writing surface.

7. The book carrier organizer tray of claim 1 wherein at least one of the plurality of receptacles is spaced from the writing surface.

8. The book carrier organizer tray of claim 1 wherein the base is hollow.

9. The book carrier organizer tray of claim 1 wherein the base includes a flange extending from a lower edge of the plurality of sides of the base.

10. The book carrier organizer tray of claim 1 wherein the writing surface has a front edge, a rear edge, and a pair of side edges and is inclined such that the elevation of the front edge is less than the elevation of the rear edge.

11. A combination mobile book carrier and a removable organizer tray comprising:
a frame including a plurality of supporting members which define a plurality of book receiving surfaces;
a plurality of rotatable members mounted to the lower portion, rotational movement of the rotatable members permitting movement of the frame;
a base carried by the frame and sized for resting on one of the book receiving surfaces, the base including a plurality of sides and a top surface which is carried by the plurality of sides, the top surface defining at least one substantially planar writing surface; and
a plurality of receptacles defined in the top surface on one or both sides of the writing surface and adapted for receiving articles of different sizes and shapes.

12. The combination mobile book carrier and removable organizer tray of claim 11 wherein the book receiving surfaces are defined by vertical and horizontal supporting members.

13. The combination mobile book carrier and removable organizer tray of claim 11 wherein the base has a front side and a rear side in opposing relation to one another and the writing surface extends therebetween.

14. The combination mobile book carrier and removable organizer tray of claim 11 wherein the writing surface includes a raised stop member adjacent a front edge of the writing surface.

15. The combination mobile book carrier and removable organizer tray of claim 11 wherein the top surface of the base is substantially horizontal and the writing surface is inclined in relation to the remainder of the top surface.

16. The combination mobile book carrier and removable organizer tray of claim 11 wherein at least one of the plurality of receptacles is located on each side of the writing surface.

17. The combination mobile book carrier and removable organizer of claim 11 wherein at least one of the plurality of receptacles is located adjacent the writing surface.

18. The combination mobile book carrier and removable organizer of claim 11 wherein at least one of the plurality of receptacles is spaced from the writing surface.

19. The combination mobile book carrier and removable organizer of claim 11 wherein the base is hollow.

20. The combination mobile book carrier and removable organizer of claim 11 wherein the base includes a flange extending from a lower edge of the plurality of sides of the base.

21. The combination mobile book carrier and removable organizer of claim 11 wherein the frame includes a lower portion and an upper portion, the base being carried by the upper portion of the frame.

22. The combination mobile book carrier and removable organizer of claim 11 wherein the writing surface has a front edge, a rear edge, and a pair of side edges and is inclined such that the elevation of the front edge is less than the elevation of the rear edge.
